(19) United States
(12) Patent Application Publication
(10) Pub. No.: US 2012/0174874 A1
(43) Pub. Date: Jul. 12, 2012

(54) PET GAME ASSEMBLY AND METHOD FOR TRAINING OR OTHERWISE STIMULATING A PET

(76) Inventor: Nina Ottosson, Karlskoga (SE)

(21) Appl. No.: 13/496,697

(22) PCT Filed: Sep. 3, 2010
(86) PCT No.: PCT/SE2010/050938

§ 371 Date: Mar. 21, 2012

(30) Foreign Application Priority Data
Sep. 21, 2009 (SE) 0950687-4

(51) Int. Cl. A01K 29/00

(52) U.S. Cl. 119/707

(57) ABSTRACT

The present invention relates to a pet game assembly, comprising at least two pet game pieces, each having a body, wherein the body of one of said pet game pieces comprises at least two sections and the body of the other of said pet game pieces comprises at least one section, each of said sections having an interface surface, and wherein at least one of said pet game pieces comprises at least one recess in one section, said recess being suitable for holding a small object, characterized in at least one section of at least one of said pet game pieces having an interaction portion arranged so that said pet game piece can be arranged onto the other pet game piece.

### TECHNICAL FIELD

The present invention relates to a pet game assembly, comprising at least two pet game pieces, each having a body, wherein the body of one of said pet game pieces comprises at least two sections and the body of the other of said pet game pieces comprises at least one section, each of said sections having an interface surface, and wherein at least one of said pet game pieces comprises at least one recess in one section, said recess being suitable for holding a small object. The invention also relates to a method for training or otherwise stimulating a pet.

### BACKGROUND ART

The training of pets such as dogs, cats or birds is an important part of the lives of many, but the proper tools for performing such training have been known to be scarce and/or suffering from lack of suitability for the pets in question. One known form of training, especially popular for training dogs but also suitable for other types of animals, is a game such as a board game where the object is for the pet to find a number of hidden treats or the like inside the game. By searching for the treats and manipulating the pieces of such a game, the pet can extract the treats which will serve as a reward for using the correct behaviour.

One common problem is, however, that the game and game pieces are often manufactured in sizes and materials that make the handling of the pieces by the pet unnecessary difficult, such as too large or small pieces, or pieces that are difficult to grip by a paw or mouth. Another, perhaps more serious problem, is the predictability of known pet games. Generally, there are provided a number of recesses or indentions where treats can be placed, and a number of covering pieces cover these recesses. In other words, the places where treats may be hidden can be easily anticipated after the pet has tried the game for a few times, and therefore only a certain amount of fine motor skills are needed for solving the game and getting the treats.

Therefore, there is clearly a need for a pet game that can challenge a problem solving ability of the pet as well as the fine motor skills, and that can be adapted to suit different animals in different ways.

### DISCLOSURE OF THE INVENTION

It is an object of the present invention to solve or at least to minimise the problems described above. This is achieved through a pet game assembly according to the preamble of the appended claim 1, wherein at least one of the pet game pieces has interaction portion arranged so that said pet game piece can be arranged onto the other pet game piece. Thereby, a larger structure comprising at least the two pet game pieces can be constructed and presented to a pet, who will be faced with the challenge of deconstructing the assembly. Thanks to the variability provided by the pet game pieces being mountable one onto the other, the game can be varied, thereby training the problem solving skills as well as the motor skills of the pet.

According to an aspect of the invention, said interaction portion of a game piece is arranged to allow said game piece to cover a recess of the other game piece. Thereby, a treat for the pet can be hidden in the recess and covered by another game piece, thus allowing for a reward after the pet has been able to solve the game and gain access to the recess.

According to another aspect of the invention, at least one of said game pieces comprises at least one section with a first height that exceeds a second height of at least one other section of the same game piece. Thereby, the game piece can be made more easy to handle by the pet through providing additional grip able surfaces and shapes, and a using of the game piece as a building brick together with other game pieces of the same or a different appearance can be made more versatile in providing different placement and mounting possibilities.

According to a further aspect of the invention, one of said sections comprises interface surfaces on opposite sides of its body. Thereby, the pet game piece can also be made to interact with other pet game pieces in a more versatile way and mounted according to a preferred orientation.

According to yet another aspect of the invention, one of said game pieces has at least two recesses that extend into the body from different interface surfaces. Thereby, a treat can be hidden underneath as well as on a pet game piece, thus further creating opportunities for varying the construction of a challenging game assembly for the pet.

According to a further aspect of the invention, at least one of said sections has a quadratic interface surface. Thereby, the pet game piece can be used more efficiently as a building brick and combined with at least one other game piece in different ways. Also, said length might be a multiple of the width of the game piece, which together with the shape of the game piece also allows for more varied game construction.

According to a further aspect of the invention, at least one of said sections has a triangular interface surface. Thereby, different interaction is possible compared to game pieces of a rectangular shape, and the pet is presented a different challenge in gripping and handling the game pieces.

According to yet another aspect of the invention, said pet game assembly further comprises a pet game board, comprising a game area that is arranged to allow at least two game pieces to be placed thereon. Thereby, the pet can manipulate the game pieces more easily by using the board and its edges as an aid in gripping a game piece, for instance. A larger structure can more easily be built when the game board is used as a starting surface, thereby enabling a more complex challenge for the pet.

According to another aspect of the invention, said interaction portion comprises at least one interface surface. Thereby, the connection to the pet game pieces is facilitated, allowing for similar interface surfaces to be combined and larger game structures to be created.

According to a further aspect of the invention, said pet game board comprises interaction portion that are arranged for interacting with at least one of said pet game pieces. A secure mounting onto the game board can thereby be achieved, thereby further simplifying a larger game construction.

### BRIEF DESCRIPTION OF THE DRAWINGS

The invention will now be described in more detail with reference to the appended drawings, wherein:

FIG. 1 shows a perspective view of a pet game assembly with game pieces according to a preferred embodiment of the invention,

FIG. 2 shows a perspective view of a game board and two different types of game pieces, and vertical cross-sectional views of the two types of game pieces,

FIG. 3a shows a perspective view of the mounting of one game piece onto another game piece,

FIG. 3b shows a side view of the game pieces of FIG. 3a in a mounted state.

FIG. 4a-c show alternative shapes for a game piece, and

FIG. 5a-5b also show alternative shapes for a game piece.

### DETAILED DESCRIPTION OF THE INVENTION

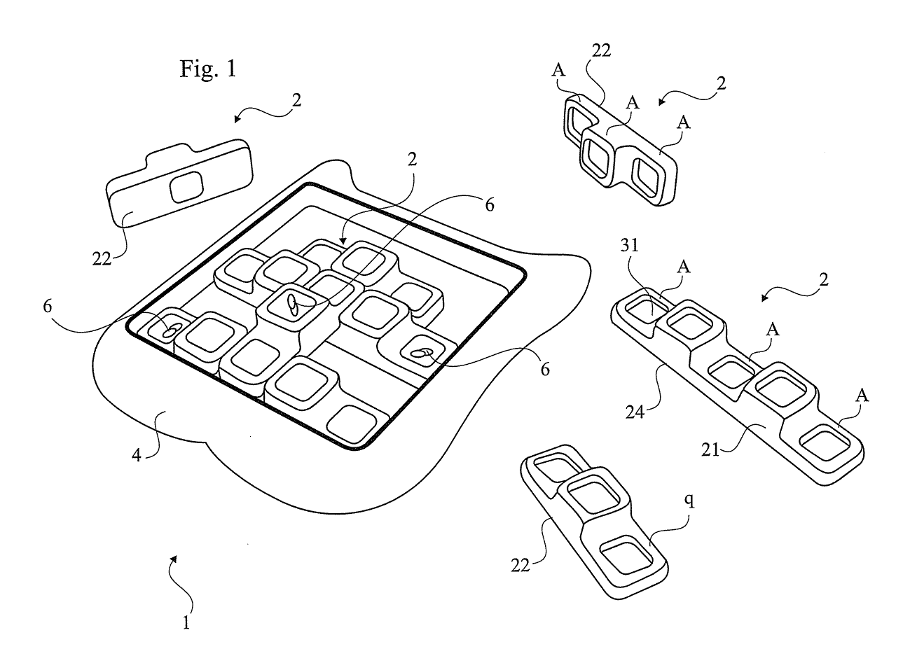

FIG. 1 shows a perspective vies of a pet game assembly 1 according to a preferred embodiment of the invention, where a game board 4 is shown together with a number of pet game pieces 2 that are mounted to form a game where a number of objects 6 that are desirable to a pet, such as treats, are hidden in the game. The game pieces 2 can be of different sizes and shapes, but generally comprise at least one recess 31 where such a treat can be placed. By mounting the different game pieces 2 together, the recesses 31 can be covered in order to hide the treats from view.

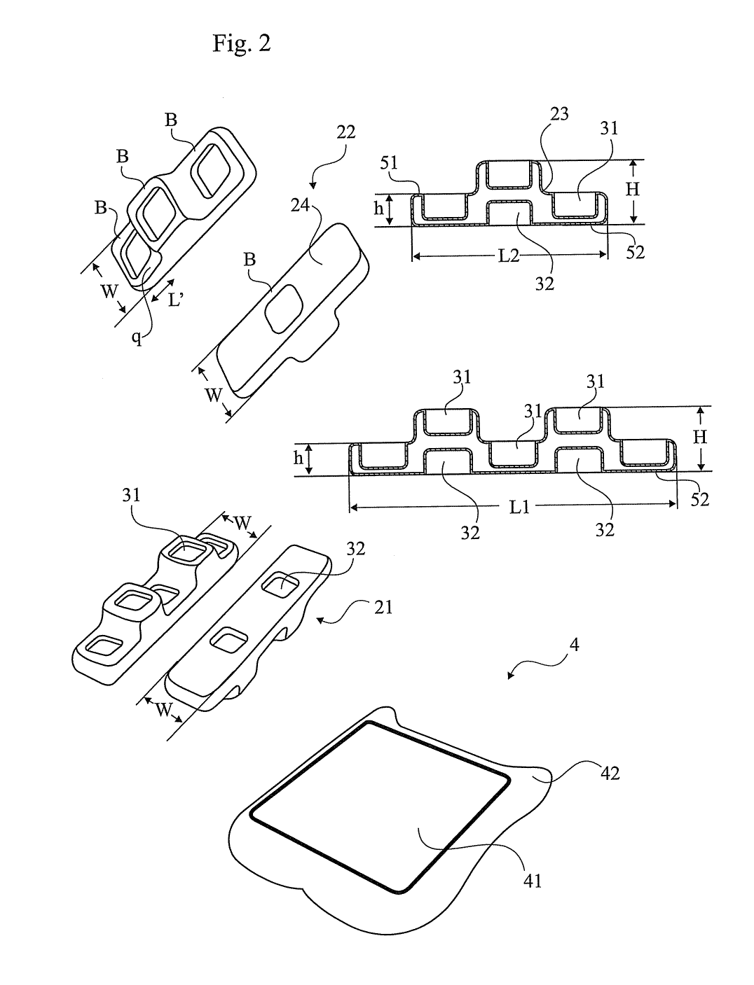

FIG. 2 shows two different types of game pieces 21, 22 in a perspective view as well as a planar view, together with a game board 4. The game pieces each have a main section, generally denoted by 24, with a first height, a width and a length, generally referred to as h, W, and L, respectively, that can differ between different pieces. In this preferred embodiment, a first game piece 21 and second game piece 22 each have similar height h and width but different lengths L1 and L2, where the length L1 is significantly larger than L2, preferably at least 1,3 times larger but more preferably at least 1,6 times. The main sections of said first and second game piece 21, 22, are generally denoted by 24.

With both types of game pieces, the length L is also significantly larger than the width W, preferably at least 1,5 times larger bur more preferably at least 2 times larger. This way, the game pieces have an elongated shape that is very suitable for interacting with each other and with a game board or other components.

The pet game pieces 2 can be divided into sections A along the length of the game piece 2, and each section A can comprise interaction portions B (shown in FIG. 2), that are meant for interacting with another game piece 2 or a game board 4 in order for the game to be mounted. The sections, with a first height H on a section 23 as opposed to a second height h, smaller than the first height H, on another section A. The height H that is significantly larger than the height h, preferably at least 1,3 times larger, more preferably at least 1,6 times larger but even more preferably at least 2 times larger. The first game piece 21 comprises one such elevated section 23, while the second game piece 22 comprises two such sections. Each game piece 21, 22 also comprises a number of recesses 31, 32 that are formed as indentions into the main section 24 and the size and shape of these indentions are selected in order to be able to contain at least one desirable object such as a treat that is suitable for the pet that is to be trained by using the pet game. As shown in the planar views of the game pieces 21, 22, the indentions 31, 32 can extend through almost the entire height h and width w, if suitable. The recesses preferably extend into the interaction portions, such as a recess 31 extended from a first side 51 of the game piece 21, 22, or a recess 32 extended from a second side 52 of said game piece 21, 22. In the areas with an extended section, recesses 31, 32 can be formed from a first side 51 as well as a second side 52 into the main section 24 of the game piece 21, 22.

In the preferred embodiment shown by FIG. 2, recesses 32 from the second side 52 are shown only at the elevated sections 23, but this may be different in other game pieces, where the distribution of first and second side recesses 31, 32 can be differently constructed.

The game board 4 generally has a game area 41 that can be surrounded by wall sections 42 for preventing a game piece 21, 22 from sliding off the game area 41. In this embodiment, the game area 41 is essentially flat in order to enable a versatile construction of each game for the pet, but this may be differently designed in other embodiments. The dimensions of the game board 4 are adapted for enabling a game construction as well as possible, and to this end it is beneficial if the game area has a length and width that are similar to or larger than the largest of the available game pieces 21, 22, in order for said pieces to be placed onto said game area 41 without being hindered by the wall sections 42. The game board 4 can also be equipped with interface surfaces and interaction portions in order to interact with one or more game pieces 2.

Also provided can be at least one covering piece that has an upper section that is arranged to be easily grip able by a pet, and a lower section that is designed for covering a recess 31, 32 in a reliable way.

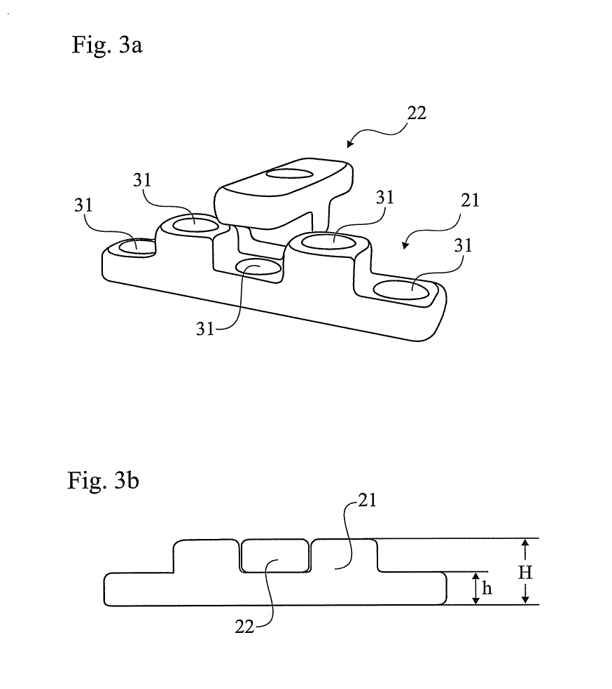

FIG. 3a shows the mounting of one game piece 22 onto another piece 21, where one end of the second game piece 22 is fitted into the area between two elevated sections of the first game piece 21 in order for one of the recesses 31 of the first game piece 21 to be completely covered by the second game piece 22. FIG. 3b shows the game pieces in a mounted state, where the second game piece 22 is clearly shown as fitted into said area of the first game piece in a reliable manner.

When playing the game with a pet, a number of game pieces 2 are used to build a structure wherein one or more treats can be hidden. In order to achieve this, a suitable number of game pieces 2 can be placed one at a time onto the game area 41 of the game board in such a way that a subsequently placed game piece 2 serves to cover a recess 31, 32 of a previously placed game piece 2 while at the same time offering new recesses 31, 32 that can be filled with treats and covered by latter game pieces 2. The first game pieces 2 placed onto the game area 41 are put onto the area 41 itself, while game pieces 2 placed later can be put onto the area 41 or onto other game pieces 2, as is found suitable at the time. Treats can be placed into some recesses 31, 32 or all recesses 31, 32, depending on the preferences of the person building the game.

After the game has been built to a suitable complexity and size, it can be presented to a pet who will be free to play with it and remove the game pieces 2 in order to reach the hidden treats. This can be achieved by gripping the game pieces 2 with a mouth or paw, or by any other suitable way, and since successful gameplay can be rewarded by finding desirable treats inside, a motivating and stimulating effect on the pet can be achieved. After the game has been taken apart and the treats found and eaten, a new game can be built and the game started again. Thanks to the possibilities of combining the game pieces 2 in different ways, the game can be different every time it is used and the problem solving skills of the pet challenged.

The game pieces 2 can be of the two types described above and shown in FIG. 2, or can be of different appearance. It might be suitable to use game pieces 2 with any number of elevated sections, or without elevated sections altogether. The pieces 2 could alternatively all have similar appearance and construction or can differ only in visual aspects such as colour or texture.

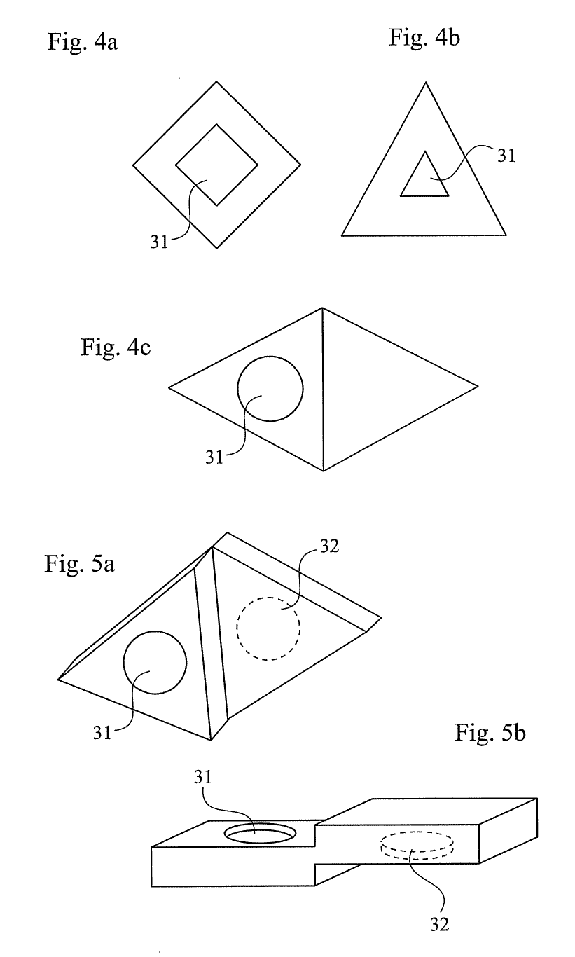

Game pieces 2 of other shapes than the essentially rectangular shapes shown in FIG. 1-3 are also possible, as shown by FIG. 4a-c and FIG. 5a-b.

FIG. 4a shows a square game piece 2 with a corresponding square recess 31, and FIG. 4b shows a triangular game piece 2 with a triangular recess 31. The shape of a recess can of course be varied according to what is deemed suitable at a particular embodiment of the invention and needs not be matched to the outer shape of the game piece 2 itself.

FIG. 4c shows a game piece 28 formed by two triangular shapes that are joined together along one side. The same game piece 28 is shown also in FIG. 5a in a perspective view, with the triangles of the game piece 28 also being mounted together in such a way that one of the triangles creates an elevated section with a recess 31, while the other triangle is mounted lower and has a recess 32 formed in the lower side of the game piece 28.

In FIG. 5b, a game piece 2 is shown, comprising two square sections that are joined together in such a way that one square forms an elevated section with a recess 32 in its lower side, while the other square forms a lower section with a recess 31 in its upper side, i.e. the same general principle as is shown by FIG. 5a but with the recesses placed differently.

The pet game pieces 2 are preferably equipped with interface surfaces on a number of interacting portions (described further below), and these surfaces are designed for facilitating the connection of one game piece 2 with another. Such interface surfaces may also be placed on the game board 4, and by matching the size of each such surface, a connection between them, allowing for an easy mounting of one game piece 2 onto another, or one game piece 2 onto the board 4, can be made.

It is to be noted that many other variations to the shape of a game piece 2 are possible, and that the distribution of recesses can be altered by what is suitable with a specific embodiment. Also, game pieces of pentagonal, hexagonal, or other shapes are possible and can be advantageous in different embodiments.

A general advantage of the variability of the shape of a game piece is the larger number of combinations possible when building a game assembly with this type of game pieces 2. If all the game pieces 2 are chosen as variations on the triangular shape, it can be advantageous if the game area 41 of a game board 4 is also triangular, for instance.

The proportions of the game piece are such that the length L is a multiple of the width W, for instance as L=2W or L=3W, etc. This is very beneficial when attempting to mount the game pieces 2 in order to create a game, since the possibilities of fitting the game pieces 2 together in different ways are greatly increased. It is to be noted, however, that the fitting does not have to be exact; it is sufficient that the length L is approximately a multiple of the width W.

The recesses 31, 32 are placed in the first side 51 as well as the second side 52, in order to further increase the possibilities of hiding treats 6 in the game. This way, a treat 6 can be hid underneath a game piece 2 or on top of it and be covered by another game piece in order to enhance the level of difficulty. Also, the game pieces have these possibilities when they are turned upside down as well, such that the second side 52 faces upwards rather than the first side 51. The distribution and number of recesses 31, 32 can of course be varied as desired.

Recesses can be placed beside elevated sections 23 as well as on top of such sections 23, and the elevated sections 23 themselves distributed differently. As can be seen in the first game piece 21, two elevated sections 23 can be placed in order to allow for a space between them where the height of the game piece 21 is the first height h. Thereby, another game piece 2 can be fitted between the elevated sections 23 in order to cover the recess 31 shown there while at the same time creating a flat surface of the two elevated sections and the surface of the other game piece 2 thanks to the relationship between the second height H and the first height h, where H=2h. This is beneficial for the game, since the use of the game pieces 2 as building bricks will further increase the stability of the game and enable a greater variation in the construction. It is to be noted, however, that the relationship between the heights H, h does not have to be precise; it is sufficient that H is approximately equal to 2 times h. Indeed, another multiple would also be possible such that H=3h, or the like.

It is also advantageous if the proportions of the game piece 2 are as shown in the Figures, with elevated sections 23 distributed in such a way that the area on the first side 51 of the elevated section is approximately square in shape and equal to the area on the first side to one side of the elevated section 23, i.e. that the same quadratic shape can be found on each of the two sides of the portion A forming the elevated section 23 of the second game piece 22, and that the same quadratic area can be found in the area between the two elevated sections 23 of the first game piece 21. Each such area q, with a length L′ that is approximately equal to the width W, can comprise a recess 31, as shown in FIG. 2, and thanks to this shape the game pieces 2 can be fitted together in a very good way with the quadratic area at one side of the elevated section 23 of the second game piece 22 being fitted between the elevated sections 23 of the first game piece 21, as is also shown in FIGS. 3a and 3b. It is to be noted, however, that it is sufficient if this area is approximately square.

The game area 41 of game board 4 can be of different shapes, such as square or rectangular, and with walls 42 on four, three, two or even one side, depending on the requirements of the game that is to be built and the pet that is to play. By having walls 42 on all four sides, the game can be more securely placed onto the game area 41, without a risk of sliding off the board 4. With three or two walls, however, the pet can more easily move the game sideways onto or off the game area 41 and use the walls 42 as leverage for manipulating the game pieces 2, which can be advantageous in some applications.

A game piece 2 can also be made in a different shape, such as for instance with a traverse section (not shown) extending from the main section 24 in the direction of the width W. Such a traverse section can be equipped with at least one recess 31, 32 and/or at least one elevated section 23 as well as interaction portion of the types described below, and thus be arranged to be able to interact with other game pieces 2 in generally the same way that a game piece 2 without a traverse section could. It would be possible to have a game piece 2 equipped with more than one such traverse section at different locations in order to for a more complex shape, or to have a traverse section that extends in other directions than that of the width W only, such as partially in the direction of the height h or the length L.

In order to achieve a good fitting and reliable construction, interaction portions in the form of indentions, extended sections, threaded sections, or the like can also be provided. Thereby, one game piece 2 can be locked into place onto another game piece 2 in order to further secure the mounting. For instance, an indention at the first side 51 of one game piece 2 might correspond to an extended section at the second side 52 of another game piece 2, and by placing the extended section into the indention, a secure mounting is achieved. This way, the game might be built in a more robust manner and allow for the pet to turn it upside down or expose it to other rough treatment without the game pieces 2 coming apart from each other. The treats can be more securely hidden and the challenge to the pet increased. Other interaction portion such as magnets could also be used, or interaction be created through the use of different materials, as described below.

By using suitable interaction portion, the game can also be played without the need for a game board 4, or allow for constructions of increasing height and complexity while maintaining stability.

The materials suitable for the game pieces 2, game board 4 and covering pieces can be chosen for each application or type of pet. A plastic material such as PE (polyethylene) has the advantages of being stable, durable, cost effective and easy to clean. By using TPU (thermoplastic polyurethane), the stable, durable and easily cleanable properties of a plastic material can be combined with a higher flexibility, giving the beneficial effect of increasing the grip able property of a game piece 2 or covering piece. Thanks to the flexibility, an interaction portion in the form of a protruding section that is to be fitted into a slot or area of limited width can be created, giving an alternative to the interaction portion described above. The same interaction portion can be achieved by using a rubber material, that would also increase the grip able property of the game piece 2 or covering piece. Alternatively, a natural material such as wood can be used, giving more weight to the game pieces 2, covering pieces or game board 4 and also providing a good grip for the pet. If suitable, a combination of the materials described herein could also be used for the game.

The size of the game board 4, game pieces 2 or covering pieces can be adapted to fit the pet in question and a suitable material chosen for giving the best game version for the pet.

The invention is not limited to the embodiments described herein, but can be varied within the scope of the appended claims, as will become apparent to the person skilled in the art. For instance, the appearance and interaction of the game pieces can be altered and many other materials used for manufacturing the game. It would also be possible to hide other objects than treats, and to adapt the size and distribution of recesses differently to the game pieces and game board. The interaction portion can also be formed by use of adhesive or interlocking materials on the game piece, such as Velcro or an adhesive that can be used and re-used. Also, magnetic areas of different strength can be integrated with the game piece in order to enable different mounting and de-mounting.

1-12. (canceled)

13. A pet game assembly comprising:
at least two pet game pieces, each having a body, wherein the body of one of said pet game pieces comprises at least two sections and the body of the other of said pet game pieces comprises at least one section, each of said sections having an interface surface, and wherein at least one of said pet game pieces comprises at least one recess in one section, said recess being suitable for holding a small object, wherein at least one section of at least one of said pet game pieces has an interaction portion arranged so that said pet game piece can be arranged onto the other pet game piece.

14. The pet game assembly according to claim 13, wherein said interaction portion of a game piece is arranged to allow said game piece to cover a recess of the other game piece.

15. The pet game assembly according to claim 13, wherein at least one of said game pieces comprises at least one section with a first height that exceeds a second height of at least one other section of the same game piece.

16. The pet game assembly according to claim 15, wherein said first height is a multiple of said second height.

17. The pet game assembly according to claim 13, wherein one of said sections comprises interface surfaces on opposite sides of its body.

18. The pet game assembly according to claim 13, wherein one of said game pieces has at least two recesses that extend into the body from different interface surfaces.

19. The pet game assembly according to claim 13, wherein at least one of said sections has a quadratic interface surface.

20. The pet game assembly according to claim 13, wherein at least one of said sections has a triangular interface surface.

21. The pet game assembly according to claim 13, wherein said pet game assembly further comprises a pet game board comprising a game area that is arranged to allow at least two game pieces to be placed thereon.

22. The pet game assembly according to claim 21, wherein said pet game board comprises at least one interaction portion that are arranged for interacting with at least one of said pet game pieces.

23. The pet game assembly according to claim 22, wherein said interaction portion comprises at least one interface surface.

24. A method for training or otherwise stimulating a pet by using a pet game assembly, said pet game assembly comprising:
at least two pet game pieces, each having a body, and at least one of said pet game pieces having at least one recess suitable for holding a small object, wherein the method comprises:
placing at least one small object that is appealing to a pet into at least one recess of one of said at least two game pieces;
mounting one of said game pieces onto the other of said game pieces in such a way that the object is hidden from view; and
presenting the mounted game pieces to a pet.
